(19) United States
(12) Patent Application Publication
(10) Pub. No.: US 2004/0219835 A1
(43) Pub. Date: Nov. 4, 2004

(54) Plug for a coaxial plug connection

(75) Inventors: Rupert Vielhaber, Rochester Hills, MI (US); Helmut Haussler, Aichtal (DE); Olaf Geertsema, Lichtenstein (DE); Ivica Segrt, Deckenpfronn (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co. KG

(21) Appl. No.: 10/821,784

(22) Filed: Apr. 9, 2004

(30) Foreign Application Priority Data
Apr. 9, 2003 (DE) 10316479.0

(51) Int. Cl. H01R 9/05

(52) U.S. Cl. 439/585

(57) ABSTRACT

A plug for a coaxial connector and cable, especially an antenna plug, in which the outer conductive sleeve is formed entirely or partly of metal by punching, stamping, cutting or the like from sheet metal and is then bent into the sleeve shape, provided around an insulator and contact pin and held around that insulator by plastic deformation.

### FIELD OF THE INVENTION

The present invention relates to a plug for coaxial cables and particularly for a coaxial plug connection with, for example, a corresponding coupling. In particularly the invention relates to an antenna plug of the type in which a pin at the center of the plug and on the conductive sleeve on the outer periphery of the plug form the electrical connection.

### BACKGROUND OF THE INVENTION

In DE 196 09 571 A1, a plug for coaxial cables and especially an antenna coupling plug, is described which basically comprises a central pin, an insulating body surrounding the pin and defining annular space therearound and a massive sleeve surrounding the insulator such that the sleeve and he pin make electrical connection in the coupling. The braid of the coaxial cable can be connected with the sleeve and the core wire of that cable can be fitted into a passage in the pin.

The metal sleeve in this case is turned or milled and may have a bulge or annular rib at its outer side which can serve as a seat for a locking member adapted to secure the plug in the coupling. The sleeve is composed of solid material and the machining thereof to the desired shape is generally expensive and time-consuming.

### OBJECTS OF THE INVENTION

It is therefore the principal object of the present invention to provide an outer sleeve for such a plug which can be fabricated more cost effectively and can be mounted manually or automatically.

Another object is to provide an improved plug connector for coaxial cables and especially for antennas, especially for connecting the antenna to a corresponding coupling, which is of lower cost than heretofore, is service-friendly and is replaceable in the event of damage.

It is also an object of this invention to provide an improved plug and a plug with an improved outer conductive sleeve which eliminates drawbacks of prior art systems.

### SUMMARY OF THE INVENTION

These objects and others which will become apparent hereinafter are attained, in accordance with the invention in a plug for a coaxial cable and especially an antenna cable where the plug is adapted to be received in a coupler, which comprises:

a contact pin;

an insulator coaxially surrounding the contact pin and defining an annular space therewith; and

an outer conductive sleeve bent into a sleeve shape from a stamped, punched or cut blank of plastically deformable sheet metal surrounding the insulator and lying against an outer surface thereof.

According to the invention, therefore, the outer conductive sleeve is fabricated from a plastically deformable piece of sheet metal whose basic shape is imparted by sampling, punching, cutting or like shaping of the sheet metal and whose sleeve shape is produced by bending. The sheet metal in its base shape is formed by the bending or stamping for example, is referred to herein as a blank.

Since the punching or stamping of a sheet metal blank is a significantly simpler fabrication step than one involving turning or like machining and the bending can also take place at minimum cost, an outer conductive sleeve according to the invention is substantially less expensive than has heretofore been the case. The insulator can serve as a mandrel or former against which the sheet metal blank is bent. The insulator can have at least one and preferably a plurality of circumferential outer rings or shoulders about which the sheet metal can be bent to form corresponding annular or ring-shaped bulges in the outer sheet. These outer rings or bulges serve to guide the insulator in its radial direction and to retain the insulator relative o the outer sleeve and the pin. They form axial stops for the insulator in the outer conductive sleeve. The bulge-shaped enlargement in the outer sleeve can be produced by upsetting, rolling and the like.

The outer wall of the outer conductive sleeve can have a number of such bulge-like enlargements between which constrictive retaining segments are provided.

The outer contour of the outer conductor sleeve can also be produced in a separate step, for example by induction molding the bulges or like formations on the sheet metal sleeve.

The outer conductive sleeve can be bent directly around the internal insulator and is preferably rolled thereagainst so that the ring on the insulator form bulge-like enlargements in the outer conductive sleeve. It is also possible to prebend the outer conductive sleeve and then to insert the insulator axially into this outer sleeve. The insulator can have abutments which serve as seats for the outer conductive sleeve. It is also possible to prebend the outer conductive sleeve and then to insert the insulator axially into this outer sleeve. The insulator can have abutments which serve as seats for the outer conductive sleeve.

It is also possible to form the insulator in an injection molding process within the outer conductive sleeve. This injection molding process can be separate from or the same step as that in which the outer contour of the outer conductive sleeve is applied. The insulator can be fixed simultaneously on the cable to which the outer conductive sleeve is connected, although it is preferred to connect the outer conductive sleeve to the cable at least in part by a crimp connection, utilizing a crimp lug which can be formed as part of the outer conductive sleeve. This assembly ensures that when the plug is joined with the coupling, the contact pin surrounded by the insulator would make an appropriate contact with the contact element of the coupler while the contact sleeve makes electrical contact with the casing of the coupler. The insulator can adhesively bond to the outer conductive sleeve. When the cable is not directly connected to the insulator, as possibly in the latter case, the insulator is seated form-fittingly in the outer conductor.

The insulator normally will have a cylindrical sleeve spaced from and coaxially surrounding the contact pin and at which this insulator is lodged firmly in the outer conductive sleeve which can hug the insulator. This ensures good guidance of the insulator, contact pin and contact sleeve upon insertion into the contact element of the corresponding coupler. The pin can be lodged in a cylindrical shank of the insulator and can have therein tubular formations extending rearwardly and adapted to receive the insulating sheath of a core wire of the coaxial cable, whose conductor can be fitted into the pin.

The outer conductive sleeve can be connected by weld points at its seam or can be bonded by adhesive to hold the bent sleeve closed. It is also possible, however, to form the opposite edges of the seam with corresponding projections and recesses to allow the edges to be interfitted.

In a further embodiment of the invention, the outer conductive sleeve is inserted into a support body which has locking elements and/or a locking slider which can engage behind one or more bulge-like enlargements of the ouster conductive sleeve. The locking element can preferably form a wedge-shaped detente which can initially lock the outer conductive sleeve in the support body but which does not retain it in its final position therein. The slider can be engaged upon further movement of the outer conductive sleeve into the carrier body, for example, between the two bulges on the sleeve to hold it in its end position.

### BRIEF DESCRIPTION OF THE DRAWING

The above and other objects, features, and advantages will become more readily apparent from the following description, reference being made to the accompanying drawing in which:

FIG. 1 is a schematic longitudinal section through a plug according to the invention;

FIG. 1A is a developed view of the outer contact sleeve, i.e. a view of the blank before the rolling thereof and after stamping or punching;

FIG. 1B is an end view of the plug of FIG. 1;

FIG. 1C is a cross sectional view of an end of the plug showing the use of a ring for retaining the sleeve in its closed position after it has been rolled onto the insulator;

FIG. 2 is a similar view of a plug with a modified insulator;

FIG. 3 is a longitudinal section of a plug with a modified outer conductive sleeve and a support body; and

FIG. 4 is a longitudinal section similar to FIG. 3 with a further variant of the support body.

### SPECIFIC DESCRIPTION

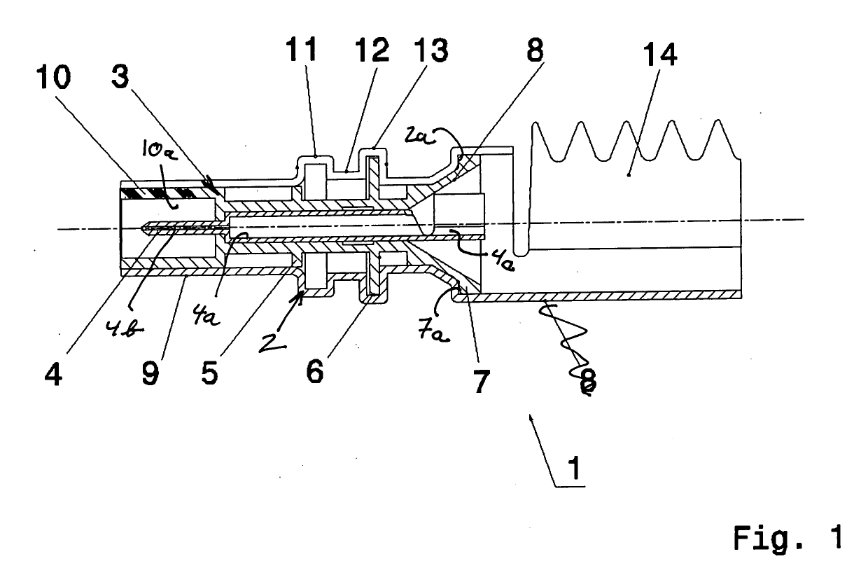

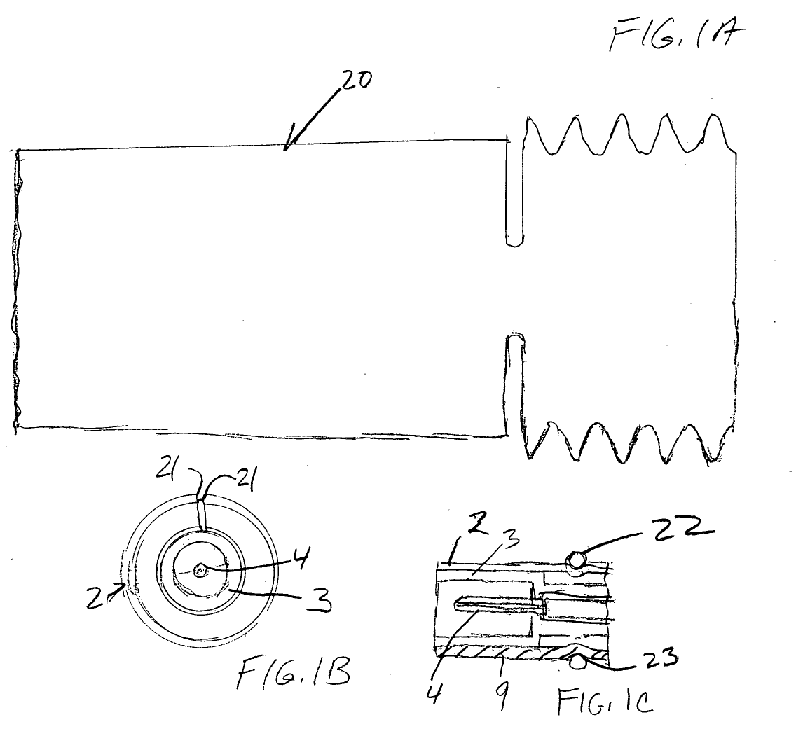

In the embodiments of FIGS. 1-4, a plug 1, which can be connected to a coaxial cable has an outer conductive sleeve 2, an internal insulator 3 and a contact pin 4. The insulator 3 has two outer rings 5 and 6, a support flange 7 and a funnel-shaped passage 8 for guiding the core conductor of a coaxial cable (not shown) into the tubular sleeve 4a of the pin 4 and the conductor wire of that core conductor into a passage 4b of the pin. A crimp lug 4c at the rear end of the sleeve 4a can be clamped on the insulation of that inner conductor. A support sleeve 10 of the insulator 3 coaxially surrounds the pin 4 and defines an annular gap 10a therewith in which a cylindrical portion of the coupler is received when the pin of FIG. 1 or FIGS. 2-4, is inserted in such coupler.

The support flange 7 of the shoulder 7a is braced against a step 2a of the outer conductive sleeve 2. The outer conductive sleeve has at its end turned toward and intended to engage in the coupler (not shown) a plug sleeve portion 9 which hugs the sleeve portion 10 of the insulator 3. The outer ring 5 of the insulator 3 supports the inner wall of the sleeve 9 while the outer ring 6 forms a bulge enlargement 13 in the outer conductive sleeve 2. Between he bulges 11 and 13 of the outer conductive sleeve 2 there is a constriction 12 which assists in retaining the outer sleeve 2 on the insulator.

On the end of the conductive sleeve 2 opposite the plug sleeve 9, there is provided a crimp lug 14 which can engage the braid of the coaxial conductor. Advantageously two such crimp lugs 14 are provided on the outer conductive sleeve 2 and can be used depending upon the cable diameter to which the plug is connected or modified depending upon the cable requirements generally.

The outer conductive sleeve 2 is fashioned from a blank 20 shown by way of example in FIG. 1A and stamped or punched from flat sheet metal and bent by plastic deformation into a sleeve shape. The enlargements 11 and 13 and the constriction 12 are formed by appropriate upsetting and/or rolling of the sheet metal strip in the embodiment of FIG. 1, for example, the strip is rolled around the insulator 3 and to the final shape shown in FIG. 1. The edges of the strip, after it is rolled around the insulator are juxtaposed at 21 as can be seen from the end view of FIG. 1B and the sheet metal strip can be held in place by point-welding or spot-welding along the seam, by adhesive bonding or by a snap ring 22 received in a recess 23 or between bulges of the outer conductive sleeve as has been shown in FIG. 1C.

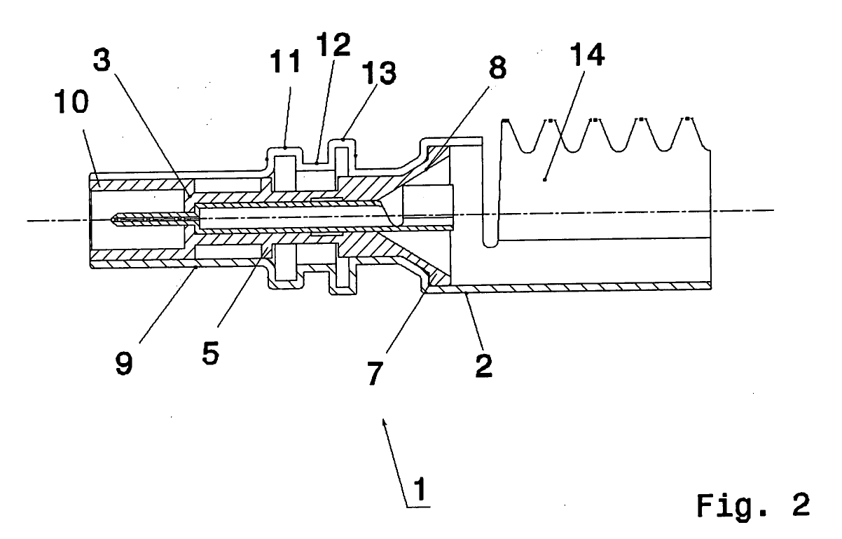

In the embodiment of FIG. 2 the insulator 3 is not received within the sheet metal strip which is then rolled round it. Rather the outer ring 6 of the insulator 3 is made smaller than in the embodiment of FIG. 1 so that the insulator can be axially inserted into the preformed outer conductive sleeve 2. In one direction the insulator is braced against the outer conductive sleeve 2 by the support flange 7 while in the opposite direction it is either supported against the cable clamped by the crimping flange or held by other means such as embossing, coining, upsetting, pressing into the insulator formation or cementing the insulator in the outer conductive sleeve.

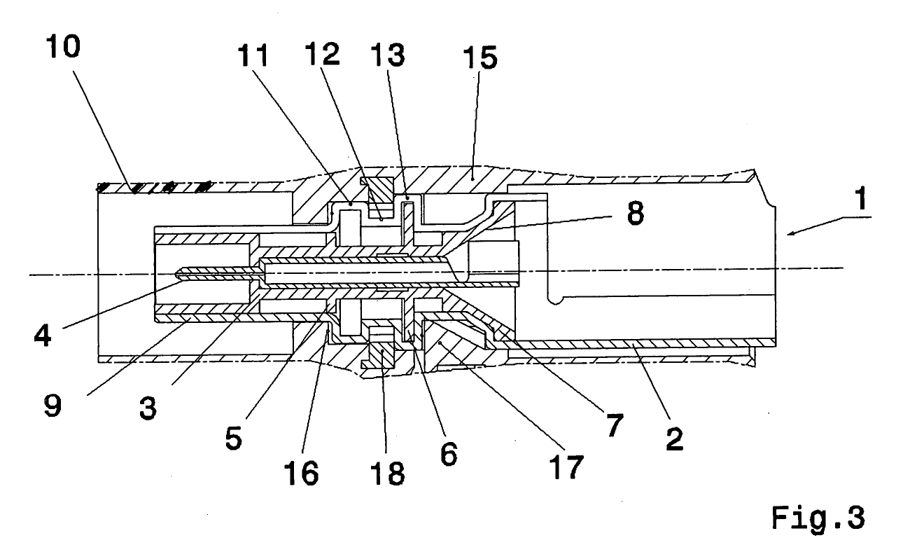

In the embodiment of FIG. 3 the outer conductive sleeve is received in a support body 15 upon insertion of the outer conductive sleeve into this body, the axial pressing of the sleeve is carried out until an abutment 16 on the body is engaged by the bulge 11. In doing so the bulge 11 is displaced past a detente formed by the preliminary locking element 18 over which the bulge 11 is forced until this detente engages in the constriction 12. The other bulge 13 thus bears against the detente element as well.

As can be seen from FIG. 3, the locking element 17 then also engages the bulge 13 and the detente element 18 can be pressed inwardly to form a final locking of the conductive sleeve 2.k The locking slider 18 is formed with an oval configuration and can be adapted to snap into the construction 12 with the bulge 11 is pressed past it.

The embodiment of FIG. 3 does not have a crimp lug and here a different type of fastening to the coaxial cable can be provided.

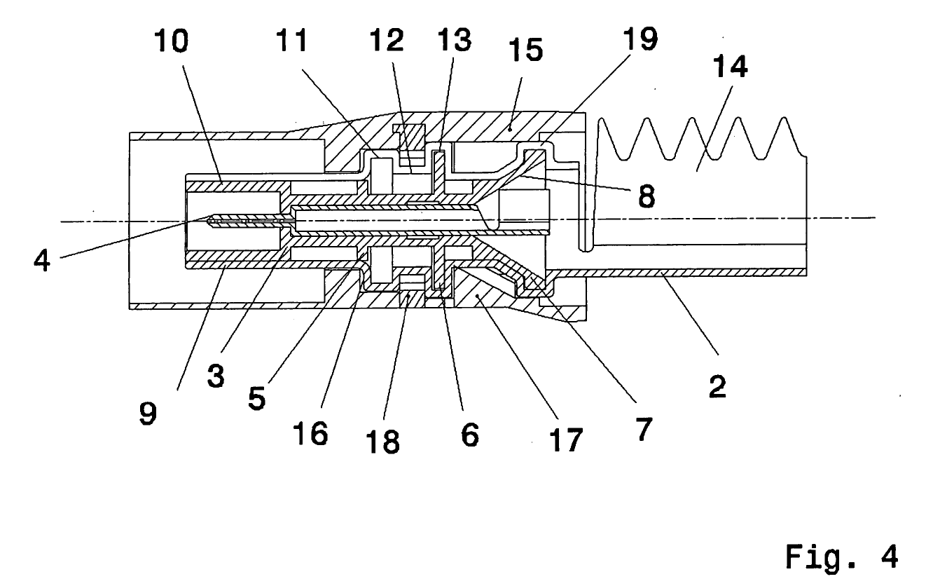

In the embodiment of FIG. 4, a crimp lug 14 is again provided and between the crimp lug 14 and the bulge 13 in the outer conductive sleeve 2, a third bulge-like enlargement 19 is provided which can have approximately the same diameter as the enlargement 13 but can be seated over the flange 7.

1. A plug for a coaxial cable adapted to be received in a coupler, said plug comprising:
a contact pin;
an insulator coaxially surrounding said contact pin and defining an annular space therewith; and
an outer conductive sleeve bent into a sleeve shape from a stamped, punched or cut blank of plastically deformable sheet metal surrounding said insulator and lying against an outer surface thereof.

2. The plug defined in claim 1 wherein said outer conductive sleeve is formed with at least one outwardly extending ring-shaped bulge.

3. The plug defined in claim 2 wherein said bulge is formed by rolling or upsetting of the sheet metal.

4. The plug defined in claim 2 wherein said insulator is formed with at least one outer ring, said bulge being formed against said ring and shaped thereby.

5. The plug defined in claim 4 wherein said insulator has at least two outer rings and said outer conductive sleeve has outward bulges around said rings and a constricted portion between said bulges.

6. The plug defined in claim 5 wherein said outer conductive sleeve has a crimp lug at an end thereof opposite an end surrounding said pin, a third bulge between the said outward bulges and said crimp lug, and a further constriction between said third bulge and said crimp lug.

7. The plug defined in claim 1 wherein said outer conductive sleeve is rolled against said insulator.

8. The plug defined in claim 1 wherein said outer conductive sleeve is surrounded by a spring ring along a portion of said insulator forming a sleeve spaced outwardly from said pin.

9. The plug defined in claim 8 wherein said outer conductive sleeve has cup shaped formations retaining the spring ring.

10. The plug defined in claim 1 wherein the outer conductive sleeve is received in a support body and is retained therein by a locking member engageable behind a bulge in said outer conductive sleeve.

11. A method of making a plug for a coaxial cable adapted to be received in a coupler, said plug comprising:
a contact pin,
an insulator coaxially surrounding said contact pin and defining an annular space therewith, and
an outer conductive sleeve surrounding said insulator and lying against an outer surface thereof, said method comprising the steps of:
(a) stamping, punching or cutting a bendable sheet metal into a basic shape for said outer conductive sleeve to form a blank;
(b) assembling said pin with said insulator; and
(c) bending said blank and fitting said blank to said insulator so that said outer conductive sleeve surrounds and lies against an outer surface of said insulator and conforms to the shape thereof.
